(19) United States
(12) Patent Application Publication
(10) Pub. No.: US 2001/0048549 A1
(43) Pub. Date: Dec. 6, 2001

(54) Camera adapter for microscope

(76) Inventor: I-Chung Wang, Taipei Hsien (TW)

Correspondence Address: RABIN & CHAMPAGNE, PC, 1101 14TH STREET, NW, SUITE 500, WASHINGTON, DC, 20005, US

(21) Appl. No.: 09/775,830

(22) Filed: Feb. 5, 2001

(30) Foreign Application Priority Data
Jun. 2, 2000 (TW) 89209483

(51) Int. Cl. G02B 21/36

(52) U.S. Cl. 359/363; 359/368

(57) ABSTRACT

A camera adapter for microscope compromising a sleeve with an internal lens tube replacing the eyepiece of a microscope and placed on the location of eyepiece. There is a thumbscrew on lower portion of the sleeve to fix the sleeve firmly on the location of eyepiece. There is a connecting ring on top of the sleeve. On the top outer rim surface of the connecting ring covers with threads, external camera can tie to the sleeve through the threads. Based on above description, an external camera can tie to a microscope by connecting the camera on the threads of the connecting ring of the sleeve. This is for connecting an external camera to a microscope without a third eyepiece.

### BACKGROUND OF THE INVENTION

I. Field of the Invention

This invention relates generally to a camera adapter for microscope and, more specifically, a sleeve with an internal lens tube to replace the eyepiece of microscope. An external camera can tie to a microscope by connecting to the sleeve.

II. Description of the Prior Art

Heretofore, in biological, medical research and criminal investigation, microscope is used to observe the tiny objects. Sometimes it is essential to record the observations for information not just to observe those by naked eyes. However it is very inconvenient to draw and record the observations by hands. Therefore there are some microscopes equipped with a third eyepiece to connect camera, digital camera or movie camera to record what is being observed. However those microscopes with third eyepiece to connect camera, digital camera or movie camera are generally very expensive, those beyond general students or amateurs' ability to afford. Normally, observation without record makes afterwards research and explanation more troublesome and inconvenient. It is also very difficult to do the information exchange without the records of observations from microscope.

### SUMMARY OF THE INVENTION

It is therefore a primary object of the invention to provide a camera adapter for microscope with one or two eyepiece and with no camera adapter an expensive alternative. In order to achieve the object set forth, a camera adapter for microscope in accordance with the present invention compromises a sleeve with an internal lens tube to place on the location of eyepiece, a thumbscrew on lower portion of the sleeve to fix the sleeve firmly on the location of eyepiece, a connecting ring on top of the sleeve, on the top outer rim surface of the connecting ring covers with threads; external camera can tie to the sleeve through the threads. Based on above description, an external camera can tie to a microscope by connecting the camera on the threads of the connecting ring of the sleeve.

### BRIEF DESCRIPTION OF THE DRAWINGS

Other objects and advantages of the present invention will become apparent from the following detailed description of the preferred embodiments thereof taken in conjunction with the accompanying drawings wherein:

FIG. 1 is schematic diagram of an embodiment of the present invention connecting camera with microscope.

FIG. 2 is an explosive view of the present invention;

FIG. 3 is a sectional view according to the present invention;

FIG. 4 is schematic diagram of the present invention with a sleeve;

FIG. 5 is an embodiment of the present invention connecting with the digital camera by a connecting ring;

FIG. 6 is another embodiment of the present invention connecting with the digital camera by a connecting ring;

FIG. 7 is a further embodiment of the present invention connecting with the digital camera by a connecting ring;

FIG. 8 is an embodiment of the present invention connecting with a movie camera;

FIG. 9 is an embodiment of the present invention connecting with a camera.

### DESCRIPTION OF THE PREFERRED EMBODIMENT

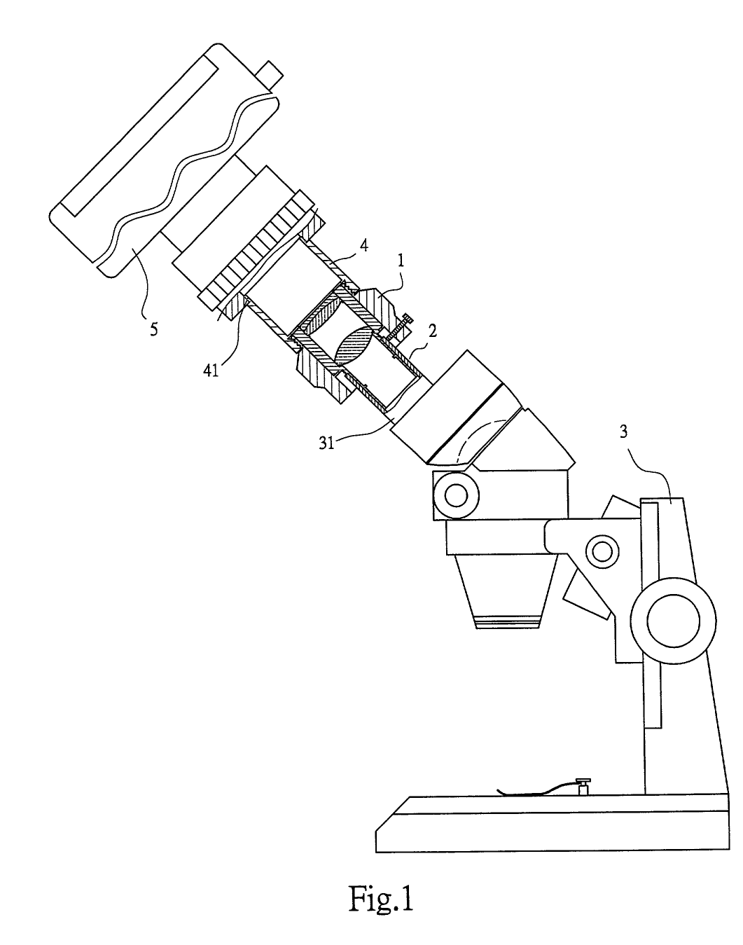

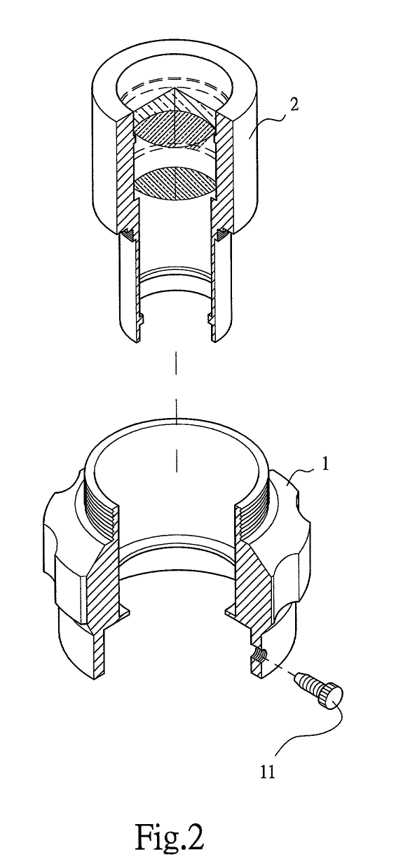

Referring to FIG. 1 and FIG. 2, the present invention is composed of a sleeve 1, inside it there is a lens tube 2 to replace the eyepiece 31 of the microscope 3 and connect to the location of the eyepiece 31. A thumbscrew 11 is on the lower portion of the sleeve 1; turn thumbscrew 11 tight can firmly fix sleeve 1 to the location of eyepiece 31 of the microscope 3. On top of the sleeve 1 is a connecting ring 4; on top outer rim of the connecting ring 4, it is covered with threads 41, an external camera 5 can be connected through the threads 41.

Based on above structure, it is first to remove the eyepiece 31 (not shown on this FIG. ) of the microscope 3 and replace it with lens tube 2 to the location of eyepiece 31 of the microscope 3. Then tie them firmly with the thumbscrew 11 on the lower portion of the sleeve 1. Finally connect camera, digital camera or movie camera 5 to the threads 41 on top outer rim of the connecting ring 4 on top of the sleeve. This is how to tie an external camera, digital camera or movie camera 5 to a microscope 3 without a third eyepiece to record the observations with external camera, digital camera or movie camera 5.

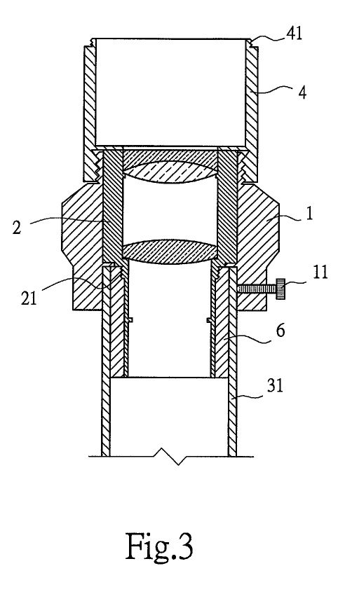

Referring to FIG. 3, in the middle portion of lens tube 2 also covered with threads 21, through threads 21 and sleeve 6; the lens tube 2 can be applied to the eyepiece 31 of a microscope 3 with different size.

There are two different specifications: 23 φ and 30 φ of the eyepiece 31 of a microscope 3. If the size of eyepiece 31 of the microscope 3 is 23 φ, as shown on FIG. 1 and FIG. 2, lens tube 2 can be applied directly. If the size of eyepiece 31 of the microscope 3 is 30 φ, tie sleeve 6 to lens tube 2 first, as shown in FIG. 3, then place them in the location on the eyepiece 31 of 30 φ.

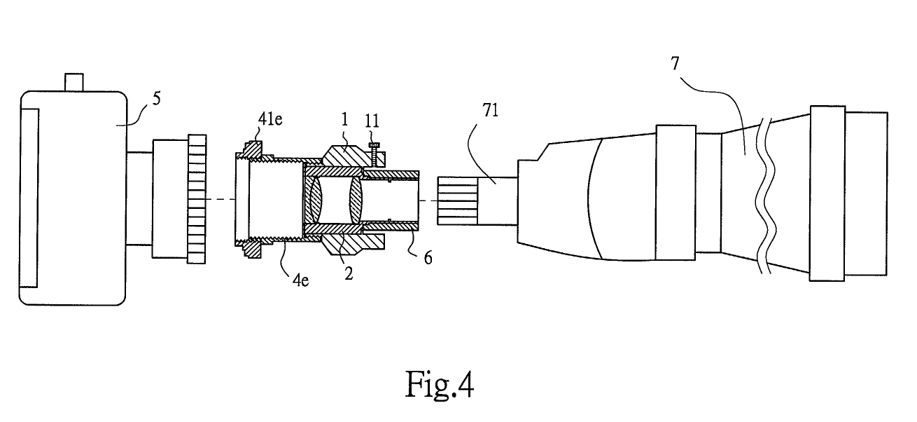

Referring to FIG. 4, if the optical instrument is a telescope 7 for bird observation or astronomy, the same method applies. It is first to connect lens tube 2 to the eyepiece 71 of the telescope 7 for bird observation or astronomy; then tie them firmly with the thumbscrew 11 on the lower portion of the sleeve 1 to eyepiece 71. In this way an external camera 5 can tie to threads 41 on top outer rim of connecting ring 4 of sleeve, the external camera 5 can record the observations.

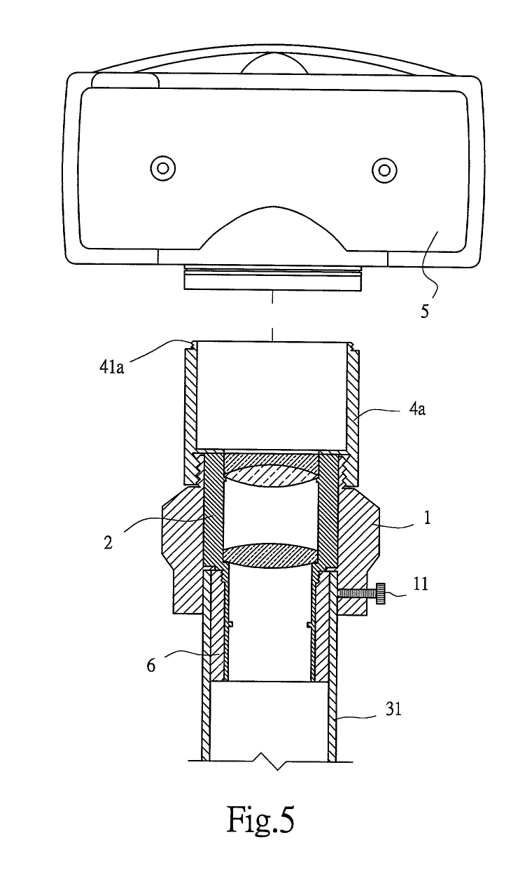

Referring to FIG. 5, the connecting ring 4a is in long tube shape; its top outer rim is covered with threads 41a; different cameras can be connected through threads 41a.

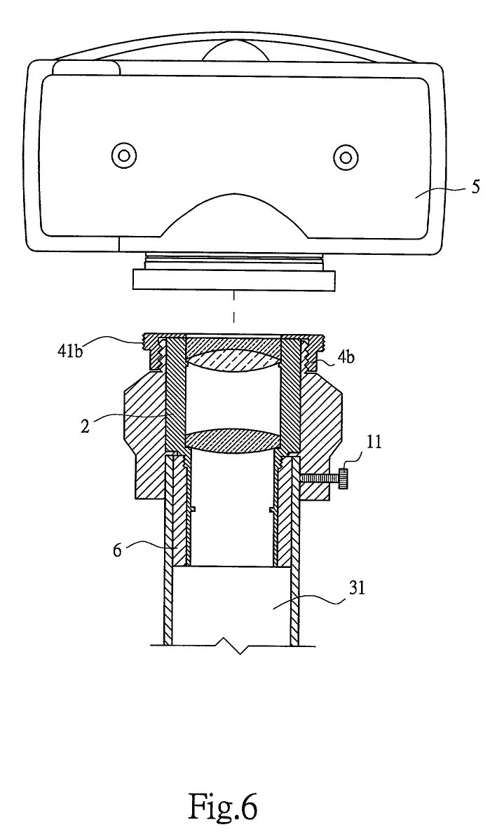

Referring to FIG. 6, the connecting ring 4b is thin; its top outer rim is covered with threads 41b, and different cameras can be connected through threads 41b.

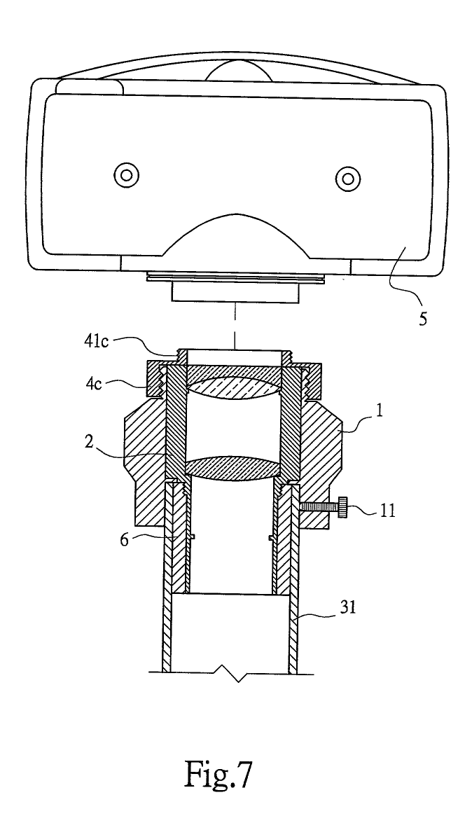

Referring to FIG. 7, the connecting ring 4c also is in round shallow shape; its top outer rim is covered with threads 41c in smaller diameter; different cameras can be connected through threads 41c.

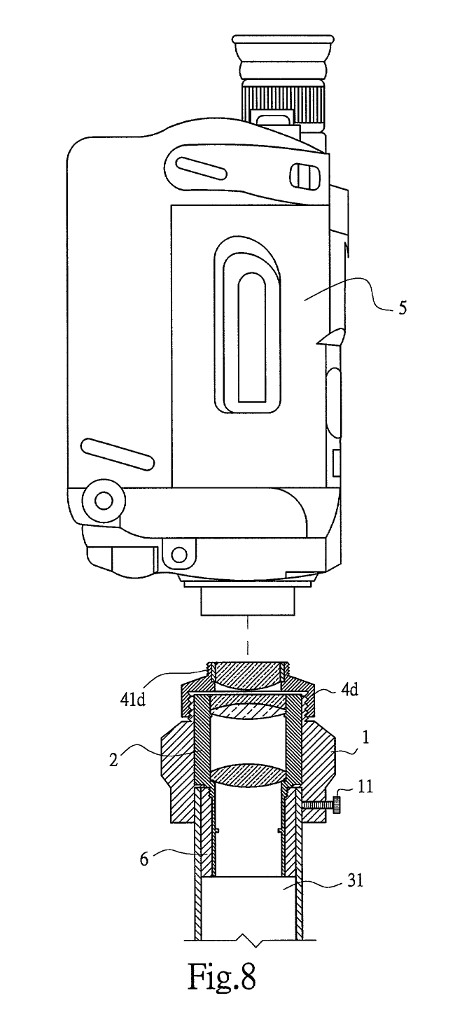

Referring to FIG. 8, the connecting ring 4d also is in round shallow shape; its top outer rim is covered with threads 41d in smaller diameter; different cameras can be connected through threads 41d.

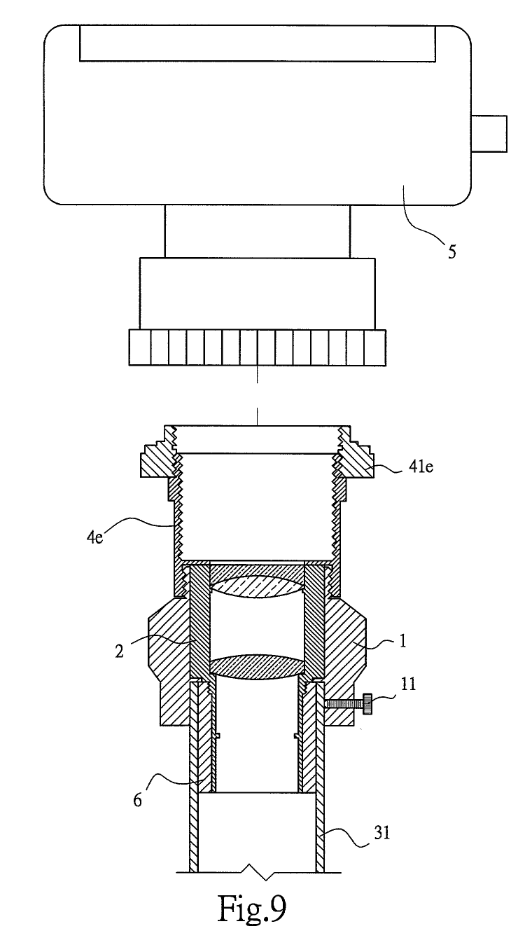

Referring to FIG. 9, the connecting ring 4e is in tube shape; its top outer rim is covered with clamps 41e; different cameras can be connected through clamps 41e.

By above description, users can choose different connecting ring 4a, 4b, 4c, 4d or 4e for different kinds of camera, digital camera or movie camera 5.

While a preferred embodiment of the invention has been shown and described in detail, it will be readily understood and appreciated that numerous omissions, changes and additions may be made without departing from the spirit and scope of the invention.

What is claimed is:

1. An camera adapter for microscope compromising:
a sleeve with an internal lens tube replacing the eyepiece of a microscope and placed on the location of eyepiece;
a thumbscrew on lower portion of said sleeve to fix said sleeve firmly on the location of eyepiece;
a connecting ring on top of said sleeve;
threads on the top outer rim of said connecting ring to connect an external camera.

2. The camera adapter for microscope as recited in claim 1, wherein said sleeve with threads in the middle portion connected to another sleeve for different sizes of eyepiece.

3. The camera adapter for microscope as recited in claim 1, wherein said connecting ring is in long tube shape, on top outer rim of said connecting ring has threads to connect to a external camera.

4. The camera adapter for microscope as recited in claim 1, wherein said connecting ring is thin, on top outer rim of said connecting ring has threads to connect to a external camera.

5. The camera adapter for microscope as recited in claim 1, wherein said connecting ring is in round shallow shape, on top outer rim of said connecting ring has threads to connect to a external camera.

6. The camera adapter for microscope as recited in claim 1, wherein said connecting ring is in round shallow shape, on top outer rim of said connecting ring has threads in smaller diameter to connect to a external camera.

7. The camera adapter for microscope as recited in claim 1, wherein said connecting ring is in tube shape, on top outer rim of said connecting ring has clamps to connect to a external camera.
